(19) United States
(12) Patent Application Publication
(10) Pub. No.: US 2013/0050560 A1
(43) Pub. Date: Feb. 28, 2013

(54) ELECTRONIC SELECTION OF A FIELD OF VIEW FROM A LARGER FIELD OF REGARD

(71) Applicants: ALLISTER MCNEISH, Austin, TX (US); WILL R. GRIGSBY, Austin, TX (US)

(72) Inventors: ALLISTER MCNEISH, Austin, TX (US); WILL R. GRIGSBY, Austin, TX (US)

(73) Assignee: BAE SYSTEMS INFORMATION AND ELECTRONIC SYSTEMS INTEGRATION INC., Nashua, NH (US)

(21) Appl. No.: 13/591,251

(22) Filed: Aug. 22, 2012

Related U.S. Application Data
(60) Provisional application No. 61/526,512, filed on Aug. 23, 2011.

(51) Int. Cl. H04N 5/225

(52) U.S. Cl. 348/335; 348/E05.024

(57) ABSTRACT

An electronic vertical adjustment focal plane assembly for electronic selection of a field of view from a larger field of regard is disclosed. In one embodiment, the electronic vertical adjustment focal plane assembly includes a lens assembly configured to focus radiation coming from an external field of view on to the focal plane assembly. Further, the electronic vertical adjustment focal plane assembly includes a fixed focal plane assembly that is oversized to substantially cover an entire field of regard and configured to receive the focused radiation from the lens assembly and to output a signal. Furthermore, the electronic vertical adjustment focal plane assembly includes a video controller electronically coupled to the signal from the fixed focal plane assembly and to generate an image based on an electronically selected desired elevational field of view.

### CROSS-REFERENCE TO RELATED APPLICATIONS

This Application claims rights under 35 USC §119(e) from U.S. application Ser. No. 61/526,512 filed Aug. 23, 2011, the contents of which are incorporated herein by reference.

### BACKGROUND OF THE INVENTION

Field of the Invention

The present invention relates to field of view elevation selection and more particularly to a system for electronically selecting the field of view.

Brief Description of Related Art

The portion of a scene called a field of view can be acquired at any time in a combat vehicle uncooled thermal imaging long wave infrared periscope assembly and is expressed in elevation and azimuth angles. The total scene area viewable by such acquisition, in driver enhancer applications, is referred to as a field of regard and is frequently larger than the field of view.

Existing techniques of selecting an elevational field of view in the combat vehicle uncooled thermal imaging long wave infrared periscope assembly use either a tilting periscope minor, or a vertically sliding focal plane assembly. Each of these techniques is used extensively and has moving mechanical parts that either tilt the minor or slide the focal plane assembly. Such moving parts may increase the complexity of the design and may result in reduced reliability over time.

### SUMMARY OF THE INVENTION

An electronic vertical adjustment focal plane assembly for electronic selection of a field of view from a larger field of regard is disclosed. According to one aspect of the present subject matter, the electronic vertical adjustment focal plane assembly includes a lens assembly, a fixed focal plane assembly, a video controller and a video display module. Further, the electronic vertical adjustment focal plane assembly includes a housing configured to house the lens assembly and the fixed focal plane assembly. In operation, the lens assembly is configured to focus radiation coming from an external field of view on to the focal plane assembly. Further, the fixed focal plane assembly, that is oversized to substantially cover an entire field of regard, is configured to receive the focused radiation from the lens assembly and to output a signal. Furthermore, the video controller, electronically coupled to the signal from the fixed focal plane assembly, is configured to generate an image based on an electronically selected desired elevational field of view. Alternatively, the electronically desired elevation field of view is selected within the focal plane assembly by the read out integrated circuit (ROIC),In addition, the video display module is configured to receive the generated image and display the generated image.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 illustrates a schematic of a tilting mirror adjustment system used to obtain a desired elevational field of view, in the context of the present subject matter;

FIG. 2 illustrates a schematic of a vertical sliding focal assembly adjustment system used to obtain a desired elevational field of view, in the context of the present subject matter;

FIG. 3 illustrates a schematic of electronically selecting an elevational field of view from a field of regard, according to an embodiment of the present subject matter; and

FIG. 4 illustrates an exploded view of an electronic vertical adjustment focal plane system, according to an embodiment of the present subject matter.

### DETAILED DESCRIPTION OF THE INVENTION

The exemplary embodiments described herein in detail for illustrative purposes are subject to many variations in structure and design.

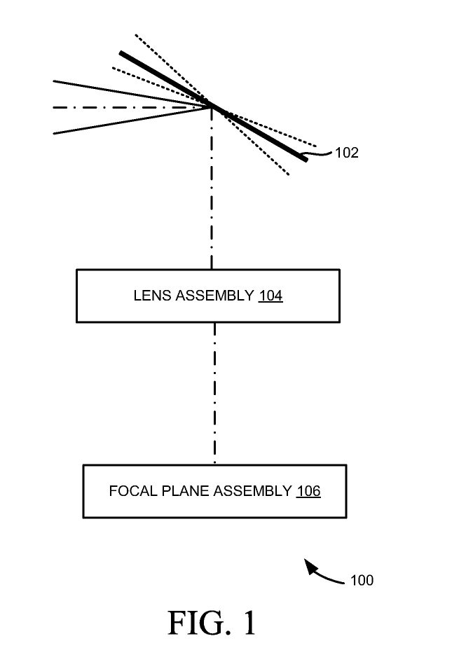

FIG. 1 illustrates a schematic of a tilting mirror adjustment system 100 used to obtain a desired elevational field of view, in the context of the present subject matter. As shown in FIG. 1, the tilting minor adjustment system 100 includes a tilting mirror 102, a lens assembly 104 and a focal plane assembly 106. In one embodiment, the focal plane assembly 106 is a fixed focal plane assembly. In operation, the tilting minor adjustment system 100 uses an adjustable angle of the tilting mirror 102 to obtain the desired elevational field of view.

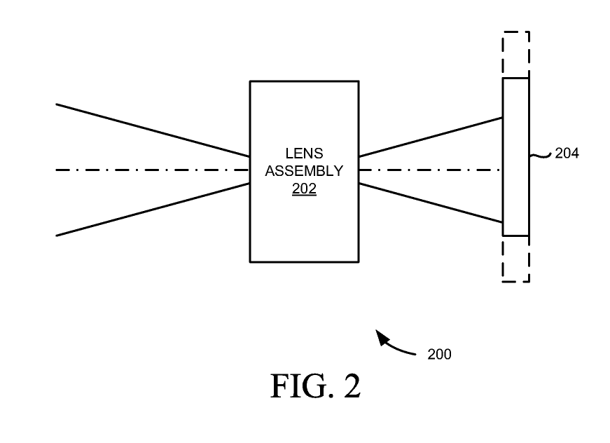

Referring now to FIG. 2, which is a schematic of a vertical sliding focal assembly adjustment system 200 used to obtain a desired elevational field of view, in the context of the present subject matter. As shown in FIG. 2, the vertical sliding focal assembly adjustment system 200 includes a lens assembly 202 and a focal plane assembly 204. In one embodiment, the focal plane assembly 204 is a movable focal plane assembly. In operation, the focal plane assembly 204 slides to adjust an elevational field of view and to obtain the desired elevational field of view.

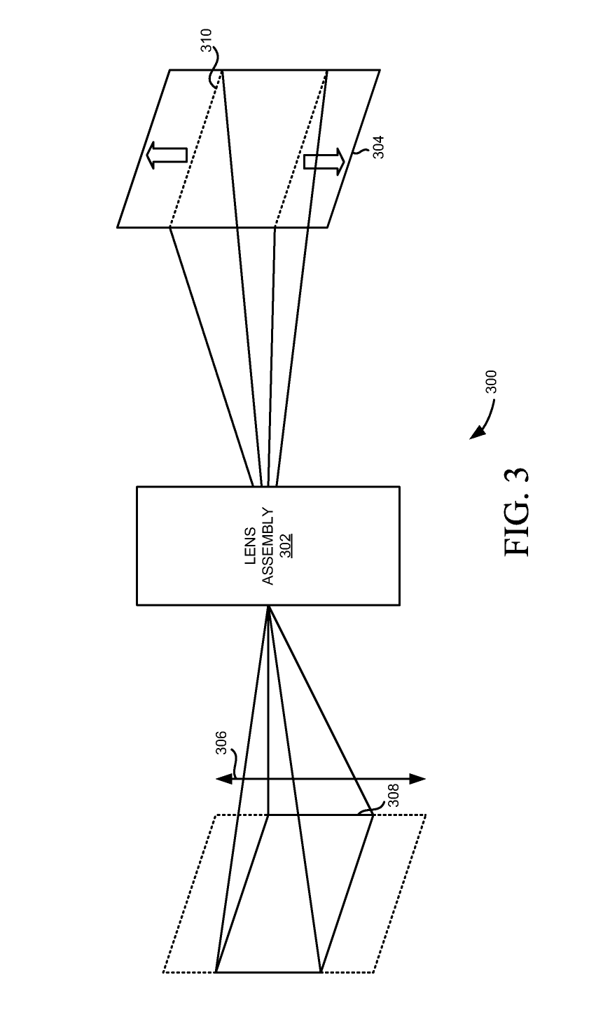

Referring now to FIG. 3, which a schematic 300 that illustrates electronically selecting an elevational field of view from a field of regard, according to an embodiment of the present subject matter. As shown in FIG. 3, the schematic 300 includes a lens assembly 302 and a fixed focal plane assembly 304 with a selected viewport 310 smaller than the larger oversized fixed focal plane assembly 304. For example, the lens assembly 302 is stationary and does not require any moving parts.

In operation, the lens assembly 302 is configured to focus radiation coming from an external field of view 308, selected from a larger elevation adjustment range 306. Further, the fixed focal plane assembly 304, that is oversized to substantially cover the entire field of regard, is configured to receive the focused radiation from the lens assembly 302 and to output a signal. In one embodiment, the elevation field of view is electronically selected over the entire elevation adjustment range 306.

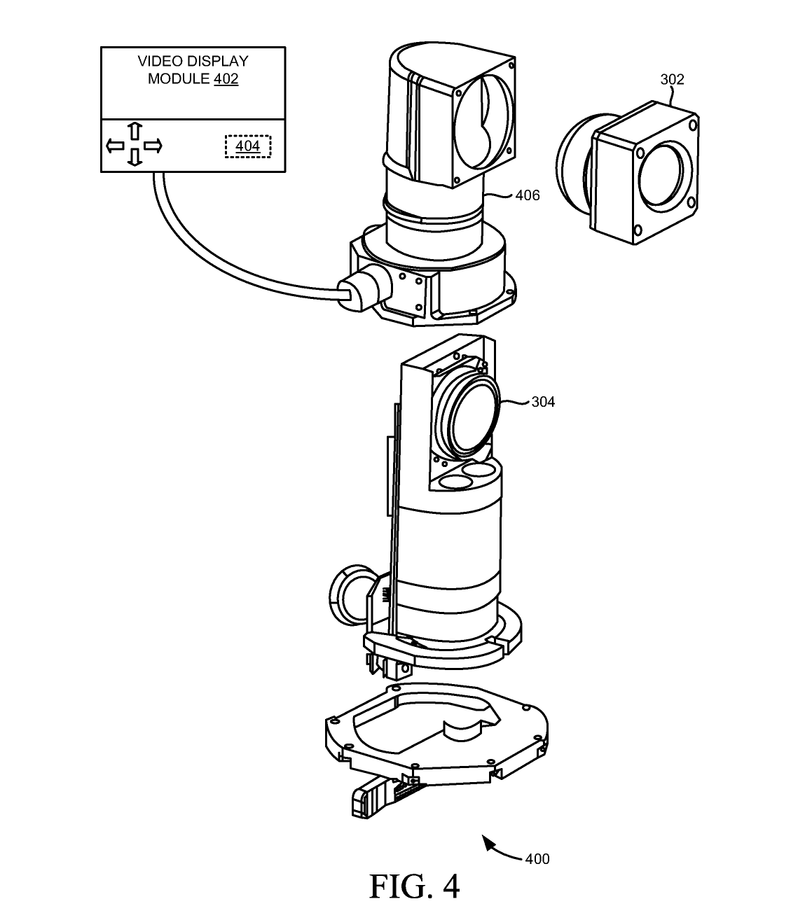

Referring now to FIG. 4, which is an exploded view of an electronic vertical adjustment focal plane system 400, according to an embodiment of the present subject matter. As shown in FIG. 4, the electronic vertical adjustment focal plane system 400 includes the lens assembly 302, the fixed focal plane assembly 304, a video display module 402 and a video controller 404. For example, the video controller 404 includes a field-programmable gate array (FPGA) video controller and the like. Exemplary fixed focal plane assembly 304 includes a radiation detector assembly and the like. Further, the electronic vertical adjustment focal plane system 400 includes a housing 406 configured to house the lens assembly 302 and the fixed focal plane assembly 304.

In operation, the lens assembly 302 is configured to focus radiation coming from an external field of view on to the focal plane assembly. Further, the fixed focal plane assembly 304, that is oversized to substantially cover an entire field of regard, is configured to receive the focused radiation from the lens assembly 302 and to output a signal. In one embodiment, the fixed focal plane assembly 304 is configured to produce a 640×480 resolution video signal. In one exemplary implementation, electronically adjusted elevational field of view can be produced by the fixed focal plane assembly 304 producing the 640×480 resolution video signal, rotated such that the 640 elements are oriented vertically. The instantaneous vertical field of view may consist of 360 elements selected from the 640 available giving a 30 degree instantaneous vertical field of view, with a 30 degree field of regard, ±11.7 degrees. In another embodiment, the fixed focal plane assembly 304 is configured to produce a 1024×768 resolution video signal. Furthermore, the video controller 404, electronically coupled to the signal from the fixed focal plane assembly 304, is configured to generate an image based on an electronically selected desired elevational field of view. In addition, the video display module 402 is configured to receive the generated image and display the generated image. Exemplary video display module 402 includes a flat panel display and the like.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. An electronic vertical adjustment focal plane assembly, comprising:
a lens assembly configured to focus radiation coming from an external field of view on to the focal plane assembly;
a fixed focal plane assembly that is oversized to substantially cover an entire field of regard and configured to receive the focused radiation from the lens assembly and to output a signal; and
a video controller electronically coupled to the signal from the fixed focal plane assembly and to generate an image based on an electronically selected desired elevational field of view.

2. The assembly of claim 1, further comprising:
a video display module configured to receive the generated image and display the generated image.

3. The assembly of claim 1, wherein the fixed focal plane assembly is a radiation detector assembly.

4. The assembly of claim 1, wherein the fixed focal plane assembly is configured to produce a VGA (640×480) resolution video signal.

5. The assembly of claim 1, wherein the fixed focal plane assembly is configured to produce a XGA (1024×768) resolution video signal.

6. The assembly of claim 1, wherein the video controller is a field-programmable gate array (FPGA) video controller.

7. The assembly of claim 1, further comprising:
a housing configured to house the lens assembly and the fixed focal plane assembly.
